(19) United States
(12) Patent Application Publication
(10) Pub. No.: US 2023/0006454 A1
(43) Pub. Date: Jan. 5, 2023

(54) Very Low Power Standby Circuit Such As For A Battery Management System

(71) Applicant: K2 ENERGY SOLUTIONS, INC., Henderson, NV (US)

(72) Inventor: Walter Bacharowski, Las Vegas, NV (US)

(21) Appl. No.: 17/788,545

(22) PCT Filed: Dec. 28, 2020
(86) PCT No.: PCT/US2020/067140

§ 371 Date: Jun. 23, 2022

Related U.S. Application Data
(60) Provisional application No. 62/956,537, filed on Jan. 2, 2020.

(51) Int. Cl. H02J 7/00; H01M 10/42; H01M 10/44; H01M 10/48

(52) U.S. Cl. CPC H02J 7/0031; H01M 10/425; H01M 10/44; H01M 10/48; H01M 2010/4271

(57) ABSTRACT

A battery system having a positive output terminal and a negative output terminal is disclosed. The positive output terminal and the negative output terminal are adapted to provide power to an external load. The battery system comprises a relay including a contactor, a battery cell for providing electrical power to the external load via the contactor, and a battery management system. The battery management system includes a controller. The controller is adapted to manage operation of the contactor. The battery management system includes a power supply circuit adapted to provide regulated power to the controller and a standby circuit comprising a bistable latch powered by the battery cell. The standby circuit is coupled to the power supply circuit of the battery management system, to selectively provide power to the power supply circuit.

### BACKGROUND

Certain rechargeable electrical energy storage devices, such as a battery or an energy storage capacitor, may have an energy storage management system. In the case of a battery, the energy storage management system is often referred to as a battery management system, or BMS.

The BMS, as well as energy storage management systems for other electrical energy storage devices such as energy storage capacitors, may include a microcontroller. The microcontroller may be powered by the very energy storage device (e.g., battery) it is managing.

To reduce battery power consumption, as well as other reasons, the BMS may have a standby mode of operation, such as which may be actuated during shipment of the battery. The standby mode may be actuated through use of a status switch, such as a push-button switch, which may be mounted on the case of the battery. While the standby mode may reduce the overall power consumption of the BMS, some power may still be consumed by the microcontroller, because the microcontroller may be required to remain active to monitor the status switch.

The present invention is provided to address this and other problems.

### SUMMARY

It is an object of the present invention to reduce the standby power to a minimum value, which may extend the shelf life of a battery when being shipped, stored, or otherwise placed in standby for future use.

In accordance with the present invention, a circuit is provided which can disconnect power from the BMS, while continuing to monitor the state of the status switch or for a connection of a charger to power terminals of the battery. The current consumption of this circuit may be on the order of 20 to 30 microamps vs. one milliamp, or more, for the BMS in standby mode.

This and other objectives and advantages may become apparent from the following description taken in conjunction with the accompanying Figures.

### DESCRIPTION OF THE FIGURES

FIG. 1 is a block diagram of a battery and associated conventional BMS;

FIG. 2 is a block diagram of the battery and BMS of FIG. 1, with the addition of a very low power standby circuit, including a bistable latch circuit, in accordance with the present invention.

FIG. 3a is a schematic drawing of a bistable latch circuit in accordance with the present invention;

FIG. 3b is a truth table for the bistable latch circuit of FIG. 3a;

FIG. 4 is a schematic drawing of a very low power standby circuit of the present invention, incorporating the bistable latch circuit of FIG. 3a; and

FIG. 5 is a timing diagram illustrating relative timing sequences for modes of operation of the standby circuit of FIG. 2.

### DESCRIPTION OF THE PREFERRED EMBODIMENTS

While this invention is susceptible of embodiments in many different forms, there will be described herein in detail, a specific embodiment thereof with the understanding that the present disclosure is to be considered an exemplification of the principles of the invention and is not intended to limit the invention to the specific embodiment illustrated.

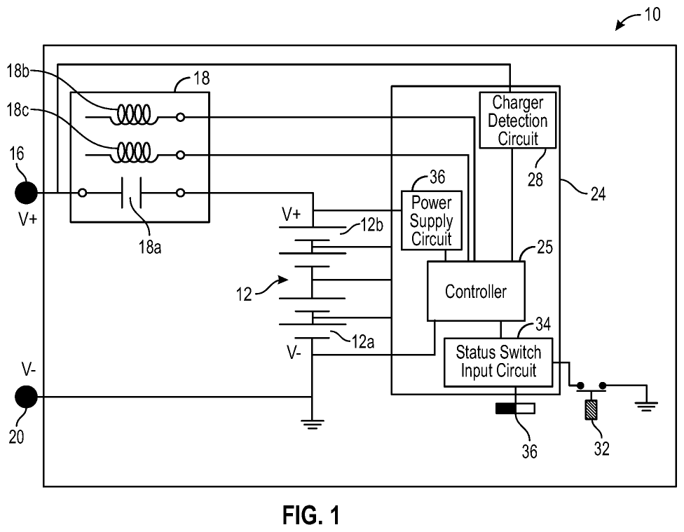

A conventional battery system, generally designated 10, is illustrated in FIG. 1. The battery system 10 may include a battery 12, which may comprise one or more battery cells 12a. Four of the battery cells 12a are illustrated in FIG. 1. The battery cells 12a may be lithium ion battery cells. While the embodiment disclosed herein is of a battery system with battery cells as rechargeable energy storage devices, the disclosure may be equally applicable to energy storage devices such as high capacity capacitors.

The battery 12 may be coupled to a positive output terminal 16, via a contactor 18a of a conventional latching relay 18. The latching relay 18 may also include an unlatching open coil 18b and a latching closed coil, and the 18c contactor 18a may be operable upon inputs to the unlatching open coil 18b and the latching closed coli 18c. The battery 12 may also be coupled to a negative output terminal 20. The positive and negative output terminals 16, 20, may be coupled to, and thereby provide DC power to, a load (not shown). A conventional battery charger (not shown) may at times be coupled to the positive and negative output terminals 16, 20, such as to charge the battery cells 12a.

The battery system 10 may also include a battery management system, or BMS, 24. The BMS 24 may operate under control of a conventional controller 25, such as an STM32L051 microcontroller, provided by STMicroelectronics, Geneva, Switzerland.

The BMS 24 may include a conventional power supply circuit 26, coupled to the battery 12 and the controller 25, to provide regulated power to the BMS 24, including the controller 25.

The BMS 24 may also include a charger detect circuit 28, coupled between the positive output terminal 16 and the controller 25, to permit the controller 25 to detect when an active battery charger has been coupled to the positive and negative output terminals 16, 20.

The BMS 24 may further include a status switch 32, such as a pushbutton switch, coupled to a status switch input circuit 34, to detect actuation of the status switch 32. The status switch 32 may be used to alter the state of the BMS between an operational mode and a standby (or “shipping”) mode. When operating in the standby mode, the battery 12 may be disconnected from the positive and negative output terminals, 16, 20. The BMS 24 may still further include a status display 36, such as to indicate the state (operational mode vs standby mode) of the BMS 24.

As can be seen, even when the BMS of FIG. 1 is operating in a standby mode, the controller must remain sufficiently active to monitor for actuation of the status switch 32, which requires a power drain from the battery 12 of the order of 1 to 2 mA range. Over time, this power drain may be significant. Further detail regarding operation of a known BMS may be found in U.S. Pat. No. 10,326,286, entitled “Battery System With Shipping Mode.”

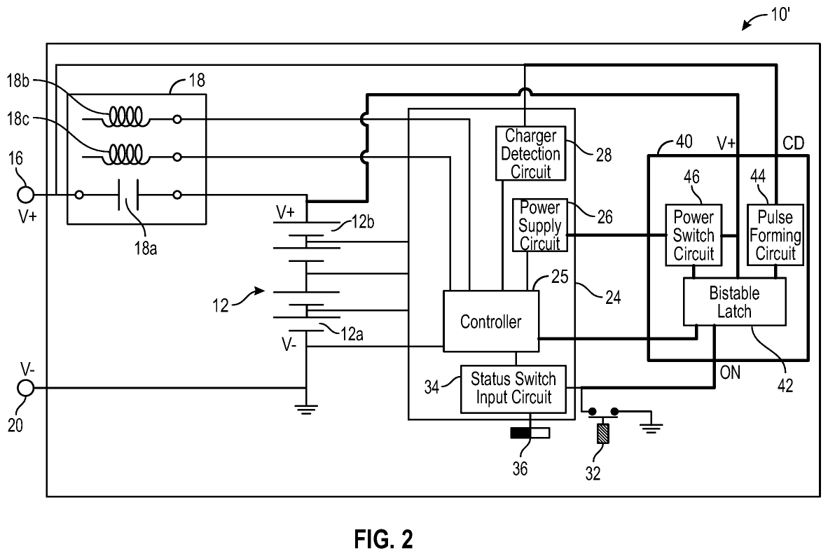

A battery system 10′, with the addition of a very low power (VLP) standby circuit 40, in accordance with the present invention, is illustrated in FIG. 2. The standby circuit 40 is provided to further reduce power drain from the battery 12, when the battery system 10′ is operating in the standby mode. Reference numbers of elements common to FIGS. 1 and 2 have been maintained.

The standby circuit 40 may include a bistable latch 42, a charger detect circuit 44 and a power switch circuit 46. The bistable latch 42 may be a one-bit memory element that maintains the current state of the BMS 24, (i.e, either ON or OFF). The charger detect circuit 44 may be a pulse forming circuit. The power switch circuit 46 may provide unregulated power from the battery 12 to the power supply circuit 26, under control of the bistable latch 42.

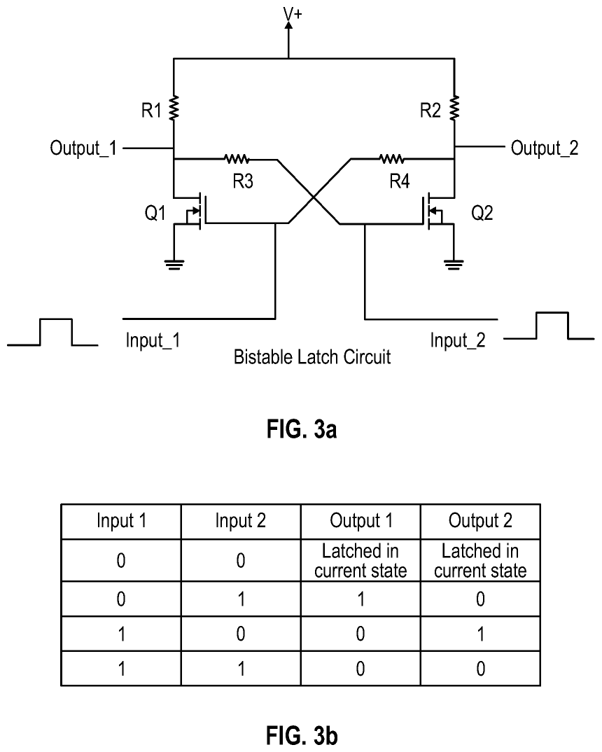

The bistable latch 42 may be implemented in various formats, and a specific form may depend on electrical specifications of the circuit with which it is being used. One embodiment of the bistable latch 42 is illustrated in FIG. 3a, which uses NMOS transistors and implements the basic logic function of a 1 bit latch or 1 bit memory.

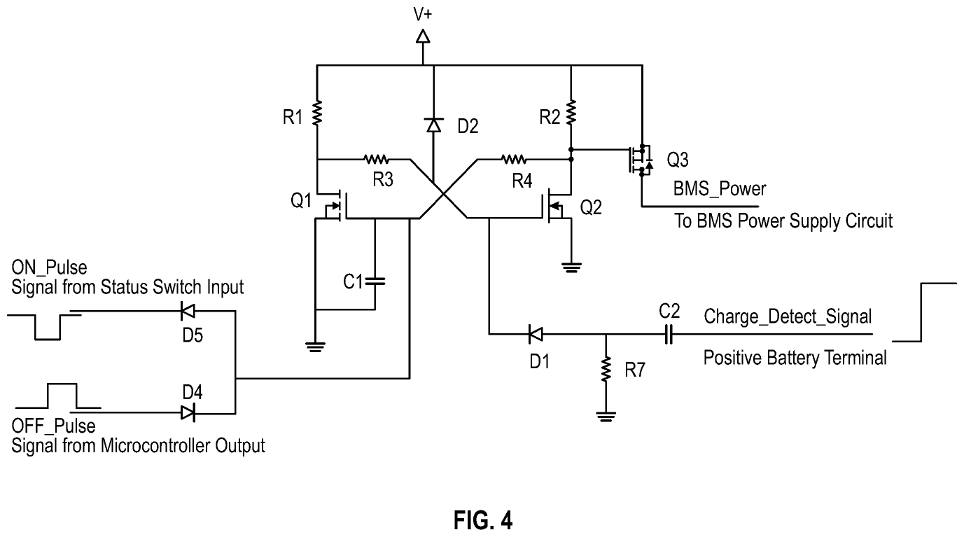

Referring to FIG. 4, capacitor C2, resister R7 and diode D1 may form the charger detect circuit 44, which may operate as a differentiator to create a pulse upon connection of a battery charger. Transistor Q3 may form the power switch circuit 46. Two cross-coupled transistors, Q1 and Q2 may form the bistable latch 42.

Referring now to FIGS. 3a and 4, the bistable latch 42 may be powered directly from the battery (V+), as the BMS 24 is at present. The bistable latch 42 may have two states, which may be controlled by the status switch 32, the BMS 24, and the charger detect circuit 28.

In the first state, power may be supplied to the power supply circuit 26 of the BMS 24, though the power switch circuit 46 (i.e., Q3). In this state, the power switch circuit 46 is turned on, providing power to the power supply circuit 26, and thereby turning on the controller 25. In the second state, the power switch circuit 46 is turned off, disconnecting power to the power supply circuit 26, thereby disconnecting power to the BMS 24. In this state, the power supply circuit 26 is turned off, turning off the controller 25.

When power is first applied to the standby circuit 40, the standby circuit 40 may startup in a state in which power is not provided by the power switch circuit 46 to the power supply circuit 26, and power is not provided to the BMS 24.

Pressing the status switch 32 (i.e., momentarily closing the status switch 32, coupling the status switch 32 to ground) may generate a logic low signal on the “ON_PULSE” input to the standby circuit 40. This may force Q1 into the OFF state and Q2 into the ON state, which may place Q3, the power switch circuit 46, into the ON state, supplying power to the BMS 24 via power supply circuit 26.

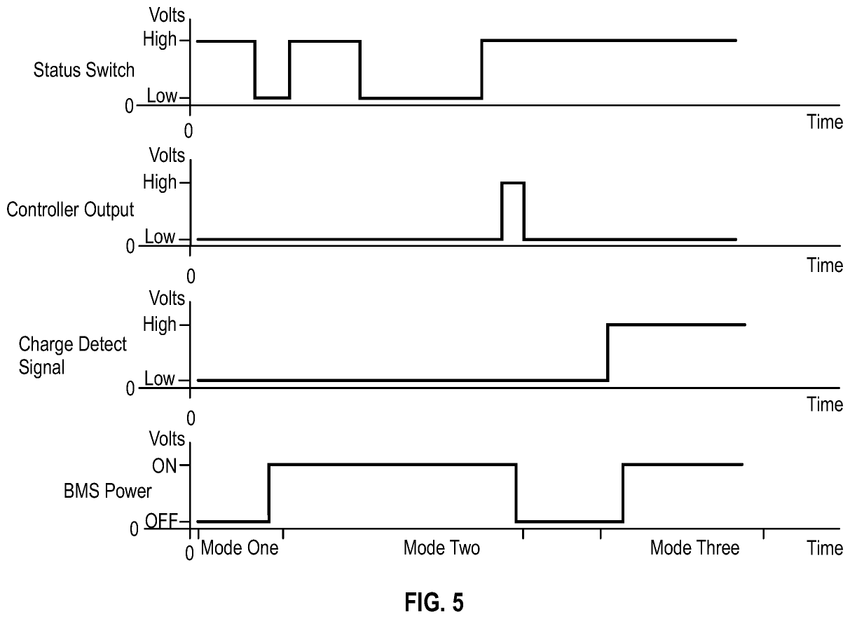

This is illustrated in FIG. 5, when the Status Switch output signal first goes low, the BMS power turns on. As also illustrated in FIG. 5, as long as the BMS power is on, again pressing the status switch 32 has no effect on the BMS power, and thus no effect on power to the BMS 24.

When the BMS is in the operational (i.e., non-standby) mode, and the status switch is depressed for time period long enough to activate the standby mode and then released, the controller 25 of the BMS 24 may open the contactor 18a. The controller may also generate a logic high signal on the “OFF_PULSE” input to the standby circuit 40. This pulse may force Q1 into the ON state which may force Q2 into the OFF-state, which may place Q3 into the OFF-state, disconnecting power to the BMS 24, via the power supply circuit 26. This may place the BMS 24 into the very low power standby mode. This is illustrated in FIG. 5, wherein when the Microcontroller Output goes high, the BMS power is off, removing power to the BMS 24.

When the BMS 24 is in the very low power standby mode and a charger is connected to the battery's positive and negative output terminals 16, 20, the charger's voltage may generate a logic high signal on the “CHARGE_DETECT_SIGNAL”, see FIG. 3, which may generate a logic high pulse through the wave shaping action of the pulse forming circuit 44 (i.e., capacitor C2, resistor R7, and diode D1). This pulse may force Q1 into the ON state and Q2 into the OFF state, which may place Q3 into the ON state, providing power to the BMS 24 via the power supply circuit 26. This is illustrated in FIG. 5, wherein when the Charge Detect Signal goes high, the BMS power signal goes high, turning on the BMS 24.

The bistable latch 42 may implement a two state (1 bit) memory element, such as an S-R latch, that may toggle between the two states based on external inputs. The memory element may be designed to minimize current draw from the battery 12 in the standby state by removing power from the BMS 24.

An advantage of using this type of standby circuit is a significant reduction in the standby current, such as from 1.75 milliamps to 28 microamps, which is 0.028 milliamps, for the circuit component values shown in FIG. 3.

Actual values of components illustrated herein may be adjusted to meet specific requirements. For example, the FET transistors may be replaced by their bipolar transistor equivalents. Additionally, the resistor values may be increased or decreased to adjust standby current and operating voltage requirements. Another variation could implement this type of circuit with latching relays.

In a prototype of the circuit disclosed, wired into a G24 battery's BMS, testing of the prototype showed the following:

Current measurement without the zero-power circuit:
a. Contactor closed, BMS is active: 1.74 mA (average).
b. Contactor open, BMS is in standby (shipping mode). 1.18 mA (average).

Current measurement with the zero-power circuit:
a. Contactor closed, BMS is active, zero power circuit active: 1.75 mA (average).
b. Contactor open, zero-power circuit active: 28 microA (average).

As discussed above, it is contemplated the present invention may be applicable to other electrical energy storage systems, such as those incorporating energy storage devices such as super- (or ultra-) capacitors.

It is to be understood that this disclosure is not intended to limit the invention to any particular form described, but to the contrary, the invention is intended to include all modifications, alternatives and equivalents falling within the spirit and scope of the invention.

1-16. (canceled)

17. An electrical energy storage system adapted to provide power to an external load, the electrical energy storage system comprising:
an energy storage cell for providing electrical power to the external load;
an energy cell management system adapted to manage the energy storage cell, the energy cell management system including a controller, wherein the controller is selectively altered between an operational mode, wherein the controller receives power from the energy cell, and a standby mode, wherein the controller does not receive power from the energy storage cell; and
a standby circuit coupled to the energy storage cell and adapted, in response to a status input, to alternatively couple and uncouple the controller to/from the energy storage cell, to respectively alter the controller between the operational mode and standby mode;
wherein the standby circuit comprises a bistable latch responsive to the status input, and a power switch circuit coupled to the energy storage cell, the bistable latch and the controller, and
wherein the standby circuit is adapted to selectively provide, and not provide, power from the energy storage cell to the controller in response to the status input.

18. The electrical energy storage system of claim 17, wherein the status input comprises actuation of a user-actuated switch.

19. The electrical energy storage system of claim 17, wherein the status input comprises detection of an active energy cell charger.

20. The electrical energy storage system of claim 17, wherein the bistable latch comprises a 1-bit memory.

21. The electrical energy storage system of claim 20, wherein the bistable latch comprises a pair of cross coupled transistors.

22. The electrical energy storage system of claim 17, wherein the energy storage cell comprises a battery cell.

23. The electrical energy storage system of claim 22, wherein the battery cell comprises a rechargeable battery cell.

24. The electrical energy storage system of claim 17, wherein the energy storage cell comprises a capacitor.

25. The electrical energy storage system of claim 17, wherein the bistable latch circuit stores the current state of the energy cell management system, independent of the state of the energy cell management system.

26. A battery system having a positive output terminal and a negative output terminal, the positive output terminal and the negative output terminal adapted to provide power to an external load, the battery system comprising;
a relay including a contactor;
a battery cell for providing electrical power to the external load via the contactor;
a battery management system including a controller, the controller adapted to manage operation of the contactor, the battery management system including a power supply circuit adapted to provide power to the controller; and
a standby circuit coupled to the battery cell and adapted, in response to a status input, to alternatively couple and uncouple the power supply circuit to/from the energy storage cell, to respectively alter the controller between the operational mode and standby mode;
wherein the standby circuit comprises a bistable latch responsive to the status input, and a power switch circuit coupled to the energy storage cell, the bistable latch and the controller, and
wherein the standby circuit is adapted to selectively provide, and not provide, power to the controller in response to the status input.

27. The battery system of claim 26, including a status switch for providing the status input, and wherein the bistable latch circuit is adapted to provide power to the power supply circuit in response to actuation of the status switch.

28. The battery system of claim 26, wherein the bistable latch comprises a pair of cross-coupled transistors.

29. The battery system of claim 26, wherein the bistable latch includes a status switch, and wherein the bistable latch circuit includes a charger detecting circuit adapted to detect connection of an active battery charger and the bistable latch circuit is adapted to provide power to the power supply circuit in response detection of the active battery charger.

30. The battery system of claim 26, wherein the bistable latch is adapted to remove power to the power supply circuit in response a command from controller.

31. A battery system adapted to provide power to an external load, the battery system comprising;
a battery cell for providing electrical power to the external load;
a battery management system including a controller and a power supply circuit adapted to provide power to the controller, the battery management system adapted to alternatively function in an operational mode or a low-power shipping mode; and
a standby circuit coupled to the energy storage cell and adapted, in response to a status input, to alternatively couple and uncouple the controller to/from the energy storage cell, to respectively alter the controller between the operational mode and standby mode;
wherein the standby circuit comprises a bistable latch responsive to the status input, and a power switch circuit coupled to the energy storage cell, the bistable latch and the controller, and
wherein the standby circuit is adapted to selectively provide, and not provide, power from the energy storage cell to the controller in response to the status input.

32. The battery system of claim 31, including means for selectively alternating the battery management system between the operational mode and the shipping mode.
